(19) United States
(12) Patent Application Publication
(10) Pub. No.: US 2026/0187342 A1
(43) Pub. Date: Jul. 2, 2026

(54) EXTRACTION OF CONTENT FROM IMAGE DATA

(71) Applicant: GOOGLE LLC, Mountain View, CA (US)

(72) Inventors: James Matthew Pollock, Beecroft (AU); Allan Douglas Knies, Burlingame, CA (US); Kejia Shao, Santa Clara, CA (US); Janet MacIntyre, Seattle, WA (US); David-Jordi Vallet Weadon, Leichhardt (AU); Mehrab Norouzitallab, Frenchs Forest (AU); Michelle Guangning Chen, Pyrmont (AU); Sanjeet Dasharath, Pyrmont (AU); Zachary Webb Partridge, Lilyfield (AU); Dac Thanh Chuong Ho, Marrickville (AU); Claire Tauziet, Redwood City, CA (US)

(21) Appl. No.: 19/425,139

(22) Filed: Dec. 18, 2025

Related U.S. Application Data
(60) Provisional application No. 63/738,937, filed on Dec. 26, 2024.

(51) Int. Cl. G06F 40/117; G06F 40/106; G06F 40/109; G06F 40/143; G06F 40/166; G06V 30/244; G06V 30/414

(52) U.S. Cl. CPC G06F 40/117; G06F 40/106; G06F 40/143; G06F 40/166; G06V 30/414; G06F 40/109; G06V 30/245; G06V 2201/02

(57) ABSTRACT

A method may extract text from image data captured from a device display rendering a first document. A method may determine a formatting style of the text based on the image data. A method may display an option that, responsive to selection, inserts the text into a second document and preserves the formatting style of the text.

### CROSS-REFERENCE TO RELATED APPLICATION

This application claims priority to U.S. Provisional Patent Application No. 63/738,937, filed on Dec. 26, 2024, the disclosure of which is incorporated by reference herein in its entirety.

### BACKGROUND

Users of computing devices often need to transfer content from a source, such as a first application window, to a destination, such as a second application window. This process can be inefficient, requiring numerous user interactions like mouse clicks, keyboard inputs, and context switches between applications, which consumes system resources and reduces user productivity. The problem is compounded when the source content is in a format that does not allow for direct text selection and copying, such as an image file (e.g., a screenshot, a scanned document, or a photograph of text).

### SUMMARY

The present disclosure relates to technology that makes it easier for users to transfer information from images, like screenshots and photos, into different applications while keeping the original formatting. The described techniques intelligently analyze an image to understand not just the text, but also its layout, font styles, colors, and structure (like tables and lists). In some implementations, suggestions for actions may be provided for the content. In some implementations, the operating system may support the techniques, which enables extraction of content no matter what application has generated the content. Put another way, the method can be applied to any content displayed by the computing device. The disclosed techniques can automatically suggest the best application for the copied content and past it in a way that preserves the original look and formatting, including structural formatting. In one example, the method supports extracting data representing text from the image data and including the data in a document. The data representing text may be included in the document with a formatting style for the data determined from the image. The document can be a new document or an existing document.

In some aspects, the techniques described herein relate to a method including: extracting text from image data captured from a device display rendering a first document; determining a formatting style of the text based on the image data; and displaying an option that, responsive to selection, inserts the text into a second document and preserves the formatting style of the text.

In some aspects, the techniques described herein relate to a system including: a processor; and a memory configured with code operable to: extract text from image data captured from a device display rendering a first document; determine a formatting style of the text based on the image data; and display an option that, responsive to selection, inserts the text into a second document and preserves the formatting style of the text.

In some aspects, the techniques described herein relate to a non-transitory computer-readable medium storing instructions that, when executed by a processor, cause a processor to: extract text from image data captured from a device display rendering a first document; determine a formatting style of the text based on the image data; and display an option that, responsive to selection, inserts the text into a second document and preserves the formatting style of the text.

### BRIEF DESCRIPTION OF THE DRAWINGS

FIG. 1 depicts an example environment for extracting content using techniques described throughout this disclosure.

FIG. 2 depicts an example environment for extracting content using techniques described throughout this disclosure.

FIG. 3 depicts an example environment for extracting content using techniques described throughout this disclosure.

FIG. 4 depicts an example environment for extracting content using techniques described throughout this disclosure.

FIG. 5 depicts an example environment for extracting content using techniques described throughout this disclosure.

FIG. 6 depicts a block diagram of a method for extracting content as described throughout this disclosure.

FIG. 7 depicts an example environment for extracting content using techniques described throughout this disclosure.

FIG. 8 depicts an example environment for extracting content using techniques described throughout this disclosure.

FIG. 9 depicts an example environment for extracting content using techniques described throughout this disclosure.

FIG. 10 depicts an example environment for extracting content using techniques described throughout this disclosure.

FIG. 11 depicts an example environment for extracting content using techniques described throughout this disclosure.

FIG. 12 depicts an example environment for extracting content using techniques described throughout this disclosure.

FIG. 13 depicts a system diagram, according to examples.

### DETAILED DESCRIPTION

The technology described herein provides a more intuitive and efficient way for users to interact with content that is ‘locked’ within images. In everyday computer use, people frequently encounter useful information in screenshots, scanned documents, or photographs—for instance, a table of data in a presentation, a list of ingredients in a recipe photo, or contact information on a digital flyer. Traditionally, transferring this information to an editable format, such as a word processor or spreadsheet, is a cumbersome manual process. A user has to re-type the text and then manually re-apply all the formatting, such as bolding, colors, and table structures. This is time-consuming and prone to errors.

The methods and systems disclosed address this challenge by automatically extracting text from an image while also analyzing and preserving its visual formatting. The system can identify structural elements like tables, lists, and headings, as well as text attributes like font size, color, and style. Based on this analysis, it can intelligently suggest a destination application (e.g., a spreadsheet for tabular data, a word processor for a formatted list) and generate instructions to reconstruct the content accurately in the new document. This streamlines the user's workflow, reduces manual effort, and ensures that the context and meaning provided by the original formatting are not lost.

The present disclosure describes methods to extract content from a first window, which can be used to complete a task in a second window. The disclosure introduces a method of including content extracted from an image that is a screenshot of the device display in a document. Content including text is extracted from the image and a formatting style of the text is determined. A document type may be determined based on any combination of the data and the formatting style. Finally, an option may be displayed to insert the text with the formatting style into a new document of document type upon selection by a user. In examples, the user may paste the text with the formatting style into a new document. A language model may be used to perform any combination of extracting the content from the image, segmenting the image, determining a formatting style of the text, and/or determining a document type, as will be further described below.

The present disclosure further describes methods to select content including text from a window in a device display based on the selection of a single location within or adjacent to the area including the selected content. The content may be extracted and used to automatically execute a task in another window.

Formatting style refers to the collection of determined visual characteristics that distinguish portions of text from one another to convey a non-literal meaning, including structural organization and semantic emphasis. The formatting style is derived from an analysis of pixel data in an image to identify properties such as typography, layout, and spatial relationships between text elements. This analysis translates the implicit visual structure of the image into an explicit set of reproducible formatting instructions, which comprise, but are not limited to: font attributes (such as typeface, size, color, weight, and style), text layout properties (including alignment, line height, and indentation), and spatial relationships between portions of text that represent structural or semantic meaning (such as the organization of columnar data in a table, hierarchical document headings, or the precise placement of elements within a mathematical equation).

Formatting instructions may refer to metadata and visual parameters that dictate the presentation of structural significance of content.

A spatial relationship may be defined as a set of relative positional coordinates and layout parameters determined for two or more text elements within an image. These parameters are used to generate formatting instructions that replicate the visual arrangement of the text elements. By preserving the spatial relationship, the structural context and semantic meaning of the original content (e.g., the organization of cells in a table, the hierarchy of items in a list, or the placement of components in an equation) is maintained when the text is inserted into a destination document.

Conventional computer systems face a technical problem when transferring content from unstructured sources, such as documents that include image data, such as screenshots, scanned documents, or photographs of text. Unstructured sources do not include formatting information about text. Existing methods, like optical character recognition (OCR) are limited to character classification and fail to extract critical formatting and layout information, including tables, lists, and font styles. This results in a loss of semantic and structural data, producing a flat text output that is information-poor. Consequently, the computing device must expend significant computational resources—processor cycles, memory, and operating system context switches—as a user manually reconstructs the lost formatting through numerous interactions, which degrades system performance and data integrity. In examples, formatting information may be defined in structured documents represented by a markup language (e.g., HTML, XML), a stylesheet language (e.g., CSS), or a document structure definition (e.g., DOM).

Conventional OCR systems may be used to extract text from the image 110, but they are technically inadequate for comprehensive content extraction because their singular focus on character classification prevents them from interpreting document structure and semantic meaning. The OCR process is incapable of parsing the underlying visual hierarchy or spatial semantics (like the Document Object Model or HTML tags that might define a source document that is the subject of a screen capture on the device display 102), resulting in the loss of information about formatting style. The failure of OCR to interpret spatial relationships and semantics means that OCR cannot understand the functional hierarchy of headings, the columnar structure of a table, or the precise arrangement of a mathematical equation. The output is therefore a technically inferior, unstructured data object—a flat, sequential stream of text that severs the link between the content and its original visual context. This information-poor output is difficult for other computer systems (like large language models) to accurately process or interpret. Consequently, these conventional systems impose a resource-intensive workflow where a user must manually reconstruct the lost formatting data through numerous inputs and context switches between applications, consuming processor cycles and memory. Furthermore, conventional workflows for selecting and acting upon image-based content are inefficient, often requiring a user to manually define desired content and then navigate a separate series of steps to initiate a relevant task.

The present disclosure provides a technical solution that overcomes these deficiencies by implementing an improved content extraction system that enhances the functionality of the computing device. Unlike conventional systems that produce unstructured text, the disclosed system is specifically configured to analyze unstructured image data to generate a structured data object that includes not only the textual content but also its associated formatting style. This is achieved by determining the spatial relationship between a first portion of the text and a second portion and generating a set of machine-readable formatting instructions. These instructions are specifically tailored for a destination document type and are configured to programmatically reconstruct the original visual hierarchy and spatial relationships when the text is rendered in the destination document. By transforming unstructured pixel data into this structured, translated output, the system enables automated and accurate integration of the content, thereby streamlining the data transfer process, improving data integrity, and reducing the computational resources (e.g., processor, memory) and user interactions required.

The present disclosure further provides a technical solution of extracting data and a formatting style from identified content in an image of a device display, determining a document type based on the data and/or formatting style, and offering the user an automatic option to include the extracted data and formatting in a document of the document type, which can be either a pre-existing document or a new document (i.e., a newly generated document).

A document type may refer to a classification of extracted content based on its semantic structure and intended use, as determined by a system model. This classification corresponds to a supported content category that dictates how the data should be structured for a destination application. The determination of a document type corresponds to selecting an appropriate application category, such as a spreadsheet application for a table, a calendar application for a calendar event, or a word processing application for long-form text.

Examples of such document types or content categories include, but are not limited to, calendar_event, contact, table, long_text, and text. Each document type may inform a second-stage process that generates the appropriate formatting instructions or structured data for the destination.

Formatting instructions may include a set of machine-readable data, generated from the visual analysis of an image, which specifies how extracted text should be rendered in a destination document to preserve its original formatting style, including its visual hierarchy and spatial relationships. Formatting instructions may include a translated representation of a visual layout, converting visual cues from an image into a specific command syntax, such as markup tags or style sheet properties, which is interpretable by a destination application. A set of formatting instructions may be a data structure that logically associates segments of extracted text with corresponding rendering parameters, enabling a destination document of a different type to reconstruct the content with its original structural and semantic context intact.

The present disclosure further provides a technical solution of selecting relevant content on a device display in response to a selection of a single location on the device display. This solution further reduces the interactions between the computing device and the user. The location can be adjacent to or within the selected relevant content. The selection can be via a mouse click, a touch, an eye gesture (e.g., gaze detection). The solution provides an option to execute a task with that content automatically in a guided human-machine interaction process.

The process of determining the formatting style from the image data involves a multi-step analysis performed by the content extraction system. Initially, the system may employ computer vision algorithms to perform layout analysis on the image. This can include identifying contours and bounding boxes around distinct blocks of text, lines, and potential graphic elements. By analyzing the coordinates and dimensions of these bounding boxes, the system determines the spatial relationship between different text portions, such as their alignment, indentation, and columnar or row-based arrangement, which is characteristic of tables.

Following layout analysis, the system performs character and word-level analysis within each text block. This involves analyzing the pixel patterns of the text to determine attributes such as font weight (e.g., by measuring stroke thickness to differentiate between bold and regular text), style (e.g., by detecting the slant of characters for italics), and color (by sampling the pixel color values). A multi-modal language model, trained on a diverse dataset of documents and their corresponding visual representations, may be used to correlate these visual cues with semantic meaning. For example, the model can learn to classify a block of text as a ‘heading’ based on its larger font size and spatial separation from subsequent paragraphs or identify items as a ‘list’ based on preceding bullet points or numbered sequences. This multi-layered analysis results in generation of a specific data structure—a structured representation of the content that captures not only the text but also the rich formatting and layout information derived directly from the unstructured pixel data of the original image.

The disclosed methods provide significant technical benefits by improving the functioning of the computing device itself. By automating the extraction and faithful reconstruction of formatting from unstructured image data, the system directly reduces the computational resources required compared to conventional workflows. This automation eliminates numerous low-level user inputs—such as mouse clicks, keyboard entries, and application context switches—each of which consumes processor cycles, memory resources, and bus bandwidth. The result is lower system overhead, faster task completion, and reduced power consumption. Furthermore, the disclosed technology enhances data integrity by transforming unstructured image data into a structured data object containing both text and machine-readable formatting instructions. This structured object enables a more accurate and complete transfer of information, improving interoperability between applications that could not otherwise share formatted content from image-based sources.

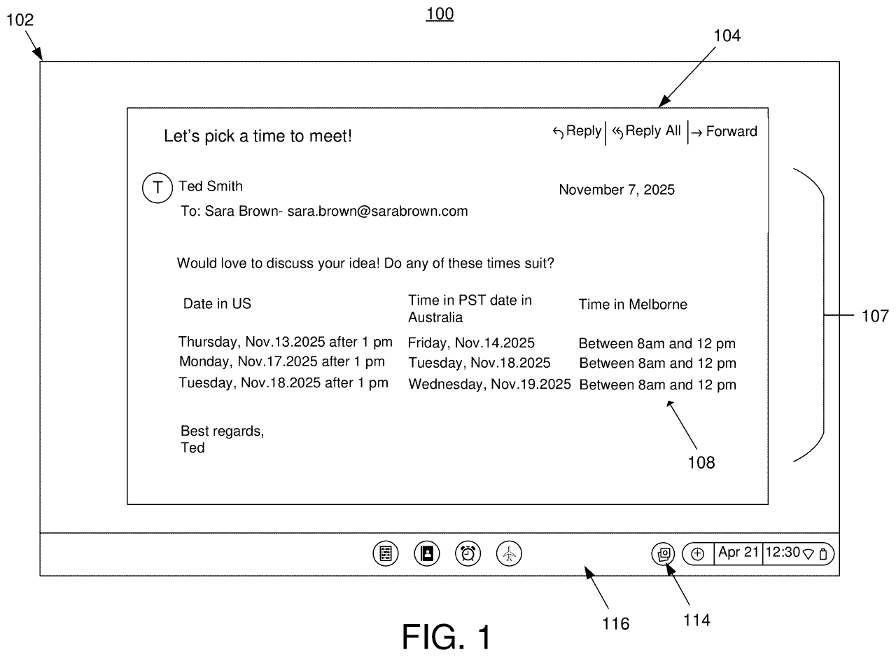

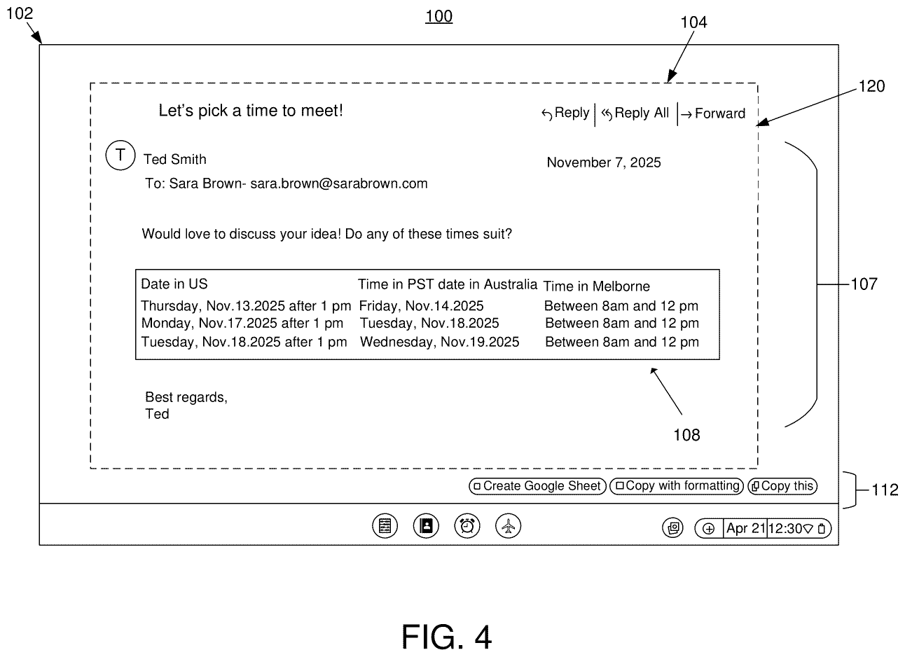

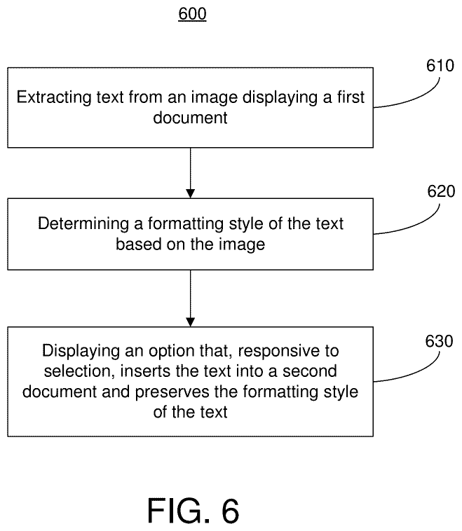

FIGS. 1-6 depict an environment for extracting the content including text displayed in a first window and inserting it into a second window using disclosed techniques. The environment 100 includes a device display 102, which displays a first window 104. In FIGS. 4 and 6, environment 100 further includes an instance of a second window 106. In examples, the device display 102 includes user interfaces executed by an operating system which may further execute one or more applications. The first window 104 and the second window 106 may execute within the same or separate applications. In examples, switching focus between first window 104 and second window 106 may include an operating system context switch.

The disclosed methods provide significant technical benefits by improving the functioning of the computing device itself. By automating the extraction and preservation of formatting, the system reduces the computational resources required compared to conventional workflows that rely on manual user reformatting. This automation eliminates numerous user inputs—such as mouse clicks, keyboard entries, and application context switches—each of which consumes processor cycles and memory, thereby leading to lower system overhead and faster task completion. Furthermore, the invention enhances data integrity by transforming unstructured image data into a structured data object containing both text and machine-readable formatting instructions. This enables a more accurate and complete transfer of information, improving interoperability between applications that could not otherwise share formatted content.

In the example of FIGS. 1-6, the first window 104 is a window of an email application and the second window 106 is a tab of a browser application. This is not intended to be limiting, however. In further examples, other combinations of applications relating to the first window 104 and second window 106 are possible that may use the methods described herein.

In FIG. 1, the first window 104 displays a first document, an email, which includes a body of text 107 with a table 108 embedded therein.

The content extraction mode may be initiated by a user and executed by the operating system. In examples, the user may launch a content extraction mode by selecting an icon 114 located in a quick launch area of the taskbar 116. A taskbar 116 is a user interface element generated by (controlled by) the operating system that provides access to currently running programs. In examples, the taskbar 116 may be on the bottom or sides of the device display 102. It may also include quick access to non-executing programs, operating system commands, (shut-down, sleep, etc.) and OS-supported widgets like a clock, system tray icons, weather, information, etc. In examples, the user may perform a gesture/action that causes a menu to be displayed, the menu including an option to select an area of the device display 102 to capture data from. The selection may be accomplished with a single selection event, e.g., a mouse click, a touch, a selection via eye gaze, etc. In an example the user may launch a device display capture option from a key on the keyboard or from an application launch pad. In an example, the operating system may launch the content extraction mode automatically upon detection that a user selected an area with a mouse.

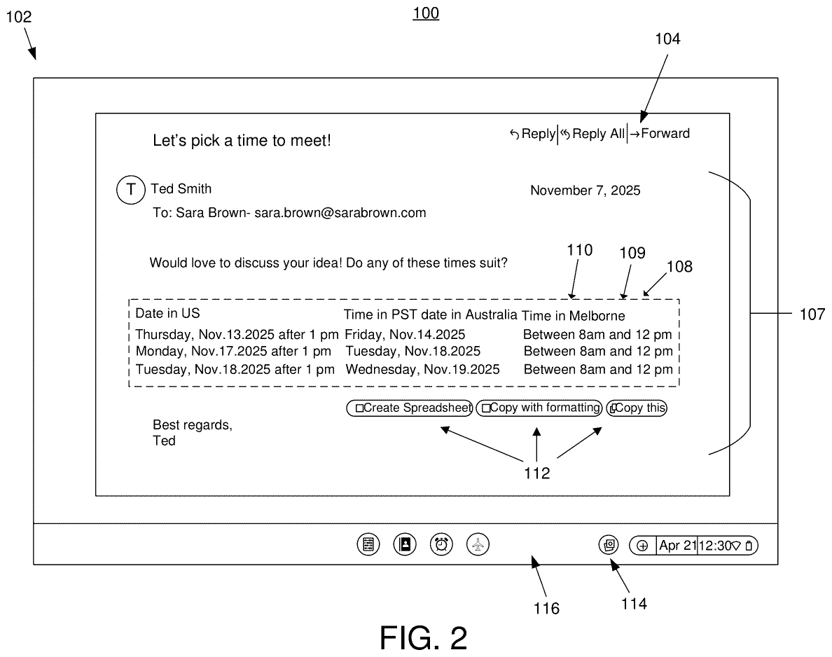

In examples, a user may take a screenshot of a portion of the device display 102. For example, in FIG. 2, a user has taken a screenshot comprising an image 110 of the table 108.

Upon entering content extraction mode, the user may select an area of the device display 702 to extract content from. In examples, selecting an area of the device display may include clicking a mouse at a first coordinate, touching the display at a first coordinate, using gaze detection to select a first coordinate, etc., and dragging it to a second coordinate to designate a rectangle. In examples, the user may draw a perimeter around an area to select an area with any shape. In examples, other methods of selecting an area are possible. For example, in FIG. 2 an example selected portion 109 comprising a table 108 is depicted.

Once the selected portion 109 of the device display 702 is selected in content extraction mode, an image may be generated including a screenshot of at least the selected portion 109. In examples, the image may include a portion of the first window 104 and/or other portions of device display 102. In examples, the image may include the entire device display 102.

Upon selection of the selected portion 109, it may be determined what tasks the user may intend to execute based on the selected portion 109. In examples, a language model may be used to determine the user intent based on the image 110. The content extraction mode may use functionality of the operating system to extract text from image 110 to offer an option to execute a task relating to the text. In examples, the image 110 may be processed with OCR to extract text. In examples, extracting the text may be extracted using a language model.

A language model, a large language model, a generative language model, or a multi-modal model is a type of machine-learning model that uses deep learning to generate a response based on a prompt and a context. A multi-model model may be able to combine inputs and outputs including text, video, audio, or image data. Language models are trained on vast amounts of data and can be configured (trained) to use this data to predict entities and/or entity types associated with webpages. For example, training data can include a dataset of images of documents paired with their underlying structured data (e.g., HTML or other markup). This training enables the model to learn the correlation between visual patterns (e.g., bolded text, table structures) and their corresponding formatting instructions. When provided with a prompt—which can be an explicit instruction or an implicit task—and an input image, the model uses its training to infer structure, identify formatting, and predict user intent, generating a structured output that includes both the extracted text and its associated formatting metadata. Using prompts and context as inputs, language models generate outputs or responses. A prompt is an input to which the language model generates a response. Prompts can include instructions, questions, or any other type of input, depending on the intended use of the model. While using a single language model is discussed below for the sake of simplicity, any combination of language models may be used to execute the functions described herein.

An example prompt may be, “determine what actions a user may want to execute based on the content in the image.” Any combination of the text and/or image 110 may be provided as in put to the model. In examples, the language model may be trained with a set of images including selected content and how that selected content correlates to user actions. In examples, few shot programming may be used to help train the language model.

Once the tasks a user may intend to execute are identified based on the image 110, one or more instances of an option 112 may be displayed correlating to those tasks. For example, FIG. 2 depicts three different instances of an option 112 based on the image 110:
create a spreadsheet, copy text with formatting, or just copy text. This is not intended to be limiting, however. In examples, any number of the option 112 are possible.

Upon selection of the option 112, a formatting style for the text may be extracted from the image. If the text was not extracted previously, it too may be extracted with the formatting style. In examples, the formatting style may include a font, size, color, underline, bold, strikethrough, italics, and/or a table, etc. For example, in table 108, information is presented spatially to represent the relationship between the data. For example, the dates are in columns based on whether it is a date in the US or a date Melbourne to meet.

In examples, the formatting style of the image 110 may be determined by using a language model. An example prompt may be, “determine the formatting of the text ‘XYZ’ in the image.” In examples, the language model may be trained with a set of images including formatted text along with the format type. In examples, few shot programming may be used to train the language model.

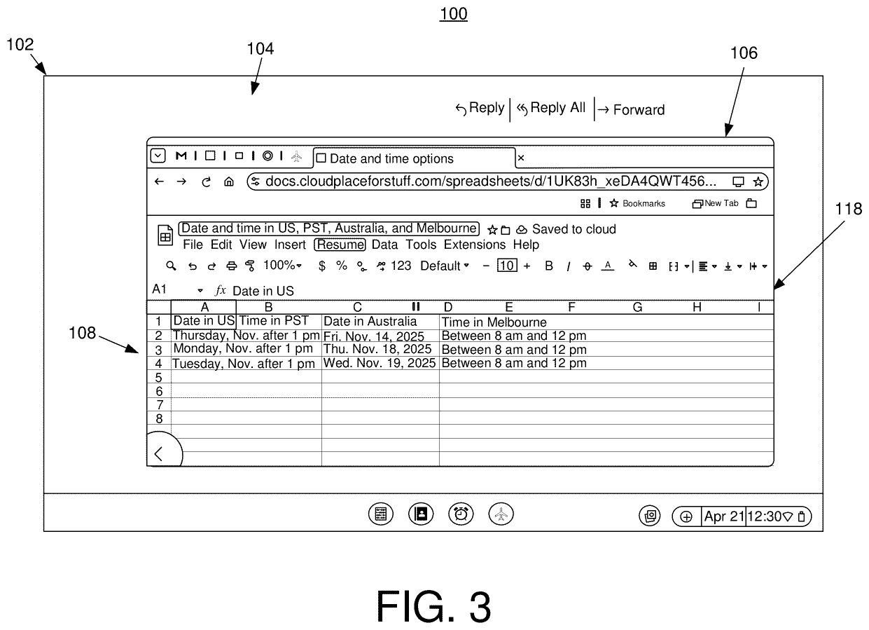

Depending on the option 112 that was selected, a task may next be executed. For example, FIG. 3 depicts a new document 118 in a second window 106 that the text 107 extracted be inserted into with the formatting style preserved upon selection of the ‘create a sheet’ option 112.

In this embodiment, the system may further analyze the extracted text to generate a metadata value for a metadata field of the new document 118. A document's title may be one example of a metadata value. As used herein, a metadata field refers to a designated data structure within a document's file format for storing metadata, that is, information about the document itself rather than its primary content. A metadata field is associated with a specific type of information, such as a document's title, author, creation date, or keywords. Populating a metadata field may include setting a metadata value for that specific field.

In examples, the system may identify key terms from the headers of the extracted table 108 (e.g., “Date in US,” “Time in PST,” etc.) to synthesize a metadata field, for example a title such as “Date and time options.”

The system may then display a second option (not shown) that, responsive to selection, sets this generated metadata value in the appropriate metadata field to serve as the title for the new document 118. In other examples, a user may select a ‘copy with formatting’ option to paste the content into an existing document, or a ‘copy text’ option to paste the text without preserving the formatting style.

In examples, the user may select the ‘copy with formatting’ instance of the option 112 to paste the text into new document 118 with a formatting style preserved. In other examples, the user may select the ‘copy text’ instance of the option 112 to paste the text into new document 118 with no formatting style preserved.

In examples where the formatting style is preserved, the language model may generate an intermediate document (not depicted) including the text that preserves the formatting style of the text of the first document displayed in first window 104, such as an HTML document. In examples, the intermediate document may be of a different document type from the initial document type that was displayed in the first window 104. If a new document is generated in the second window 106, the intermediate document may be used as input to translate the formatting style of the text into new document in a way that preserves the formatting style. If text is pasted into a new document in the second window 106, the intermediate document may be used as input to translate the formatting style of the text into new document in a way that preserves the formatting style, for example, converting HTML tags and CSS styles into the proprietary style sheet and formatting metadata of a word processing file or structuring the data into the fields required by a calendar application. This example is not intended to be limiting, however. In examples, the intermediate file and new file in the second window 106 may be any document type.

In examples, the document type of the first document displayed in first window 104 may be different from the document type of the second document. For example, the email of first window 104 is different from the spreadsheet of second window 106.

In examples, the second document type may be determined based on any combination of the text or the formatting style from the first document. In examples, the document type for the second document may be determined using other content from the image. With user permission, browser history or other on-device data/information may be used to determine the document type. For example, if data is determined to include table formatting, the document type selected may be a spreadsheet. If the formatting style is determined to be a times new roman font in bold, the document type may be determined to be a word processor file. In examples, the document type may be determined using a lookup table.

In examples, the document type may be determined by using a language model. An example prompt for the language model may include, “determine the most likely document type for the data and formatting style.” In examples, the language model may be trained with a set of images including content (including, i.e., formatted text) and a document type that is the best destination for the extracted content.

FIG. 4 depicts the device display 102 and first window 104 with a different selected portion 120. The selected portion 120 includes all of the text 107 from the email displayed in the first window 104 and the table 108, not just the table 108 that was selected in FIG. 2.

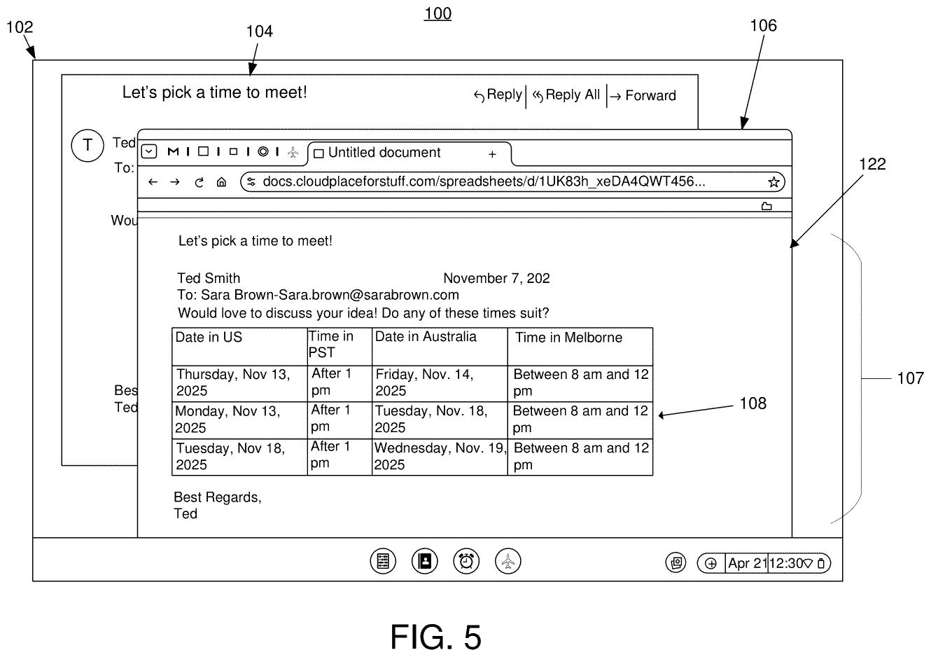

In examples, the user may be offered the same three options 112 upon selection of selected portion 120 that were offered after selection of selected portion 109. Upon selection of the option 112 to create a spreadsheet or to copy and paste with formatting, the text 107 and table 108 with formatting style may be inserted and displayed in a word processor document 122, as depicted in FIG. 5. In examples, the table 108 may be formatted in a word processor document 122 as a table object, wherein the structure and styles are defined by the document's proprietary internal metadata rather than by HTML and CSS.

FIG. 6 is a flowchart of an example method 600 for . . . [A method comprising:]

At step 610, text may be extracted from an image displaying a first document. For example, the table 108 may be extracted from the document rendered by device display 102, as described above.

At step 620, a formatting style of the text may be determined based on the image. For example, it may be determined that FIG. 2 includes a table 108, as described above.

At step 630, an option may be displayed that, responsive to selection, inserts the text into a second document and preserves the formatting style of the text. For example, the option 112, “Create Spreadsheet,” may be displayed to insert the table 108 into second window 106, as described above.

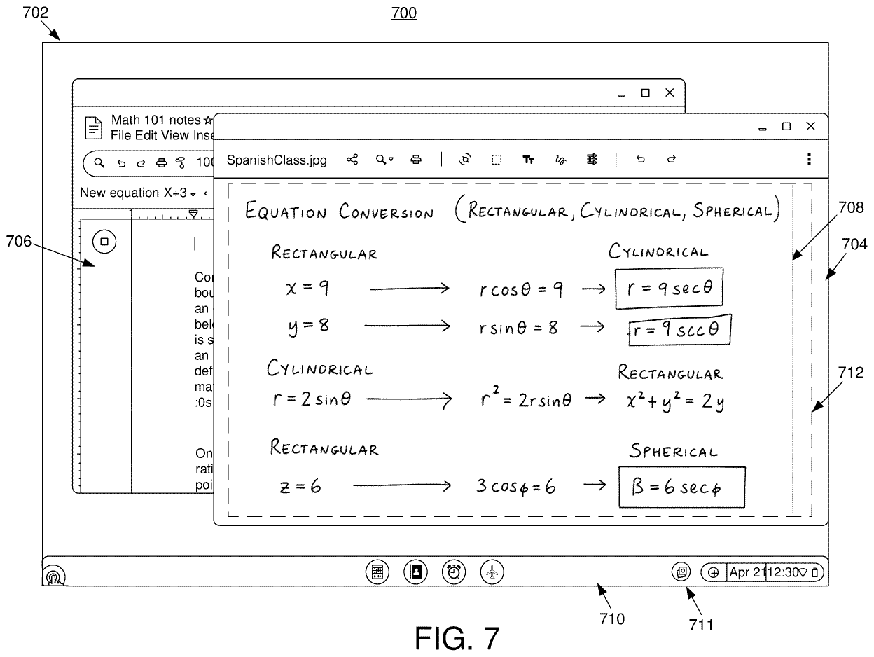

FIGS. 7-9 depict an example environment for extracting content using disclosed techniques. In the example of FIG. 7 the environment 700 includes a device display 702, which displays a first window 704 and a second window 706. In examples, the device display 702 includes user interfaces executed by an operating system which may further execute one or more applications. The first window 704 and the second window 706 may execute within the same or separate applications. In examples, switching focus between first window 704 and second window 706 may include an operating system context switch.

In the example of FIGS. 7-9, the first application is an image viewing application and the second application is a word processing application. This is not intended to be limiting, however. In further examples, other combinations of applications relating to the first window 704 and second window 706 are possible that may use the methods described herein.

In examples, the device display 702 is displaying a document 708 including an image comprising handwritten notes, which include text with description and math equations. In examples, the handwritten notes may have been dictated by hand on a piece of paper and scanned/photographed or generated by hand using an electronic writing tablet or other means of electronic capture to generate an image file.

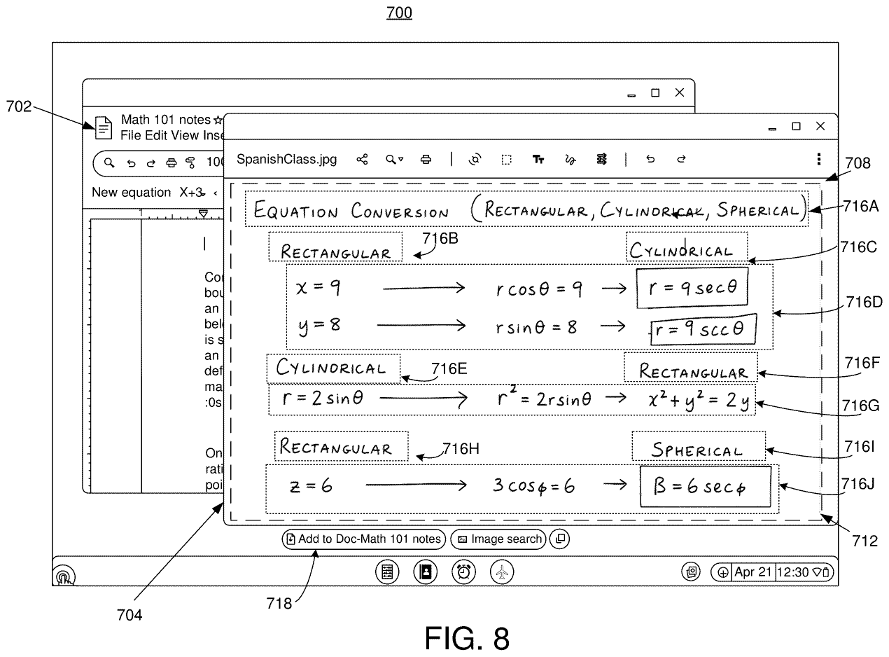

In examples, a content extraction module may extract data from the content selected by selected portion 712 by identifying data and/or formatting within it. In examples, the content in the document 708 may be segmented before or after the data is extracted to preserve the order of the content and/or identify smaller portions of the content to extract data from. For example, FIG. 8 illustrates that the selected portion 712 has been divided into segments 716A-716J.

In examples, the language model may be used to segment the image. An example prompt may read, “segment the image to generate different portions with associated data,” and one or more segments 716A-716J may be identified. Once the one or more image segments are identified, the language model may be executed for each respective segment 716A-716J with the prompt, “extract the text depicted in the image.” In examples, it may be possible to extract data via other techniques as well. For example, it may be possible to segment a document by evaluating a document object model (DOM) or an accessibility tree.

In examples, data may be extracted from one or more segments 716A-716J using an OCR module. The data extracted may comprise text, emojis, images, and so forth. In examples, data may be extracted from one or more segments 716A-716J using a language model. An example prompt may be, “extract text from the image.”

In examples, a formatting style of the data from the document 708 may be determined. The formatting style may include a font, size, color, underline, bold, strikethrough, italics, etc. For example, in the segments 716A, 716B, 716C, 716E, 716F, 716H, and 716I some words are written in all-caps, and some are written in black, blue, red, and green. In segments 716D, 716G, 716J, there are equations that may require special equation formatting and characters. In examples the formatting style may be determined via OCR, or based on the DOM, or based on the accessibility tree.

In examples, the formatting style may be determined by using a language model. An example prompt may be, “determine the formatting of the text ‘XYZ’ in the image.” In examples, the language model may be trained with a set of images including formatted text along with the format type.

In examples, a document type may be determined based on any combination of the data or the formatting style. In examples, the document type may be determined using other content from the image. With user permission, browser history or other on-device data/information may be used to determine the document type. For example, if data is determined to include table formatting, the document type selected may be a spreadsheet. If the formatting style is determined to be a times new roman font in bold, the document type may be determined to be a word processor file. In examples, the document type may be determined using a lookup table.

In examples, the document type may be determined by using a language model. An example prompt for the language model may include, “determine the most likely document type for the data and formatting style.” In examples, the language model may be trained with a set of images including content (including, i.e., formatted text) and a document type that is the best destination for the extracted content.

In examples, an option may be displayed on the device display 702 that, upon selection, inserts the data and formatting style into a document of the document type. For example, FIG. 8 illustrates that the option 718 is displayed.

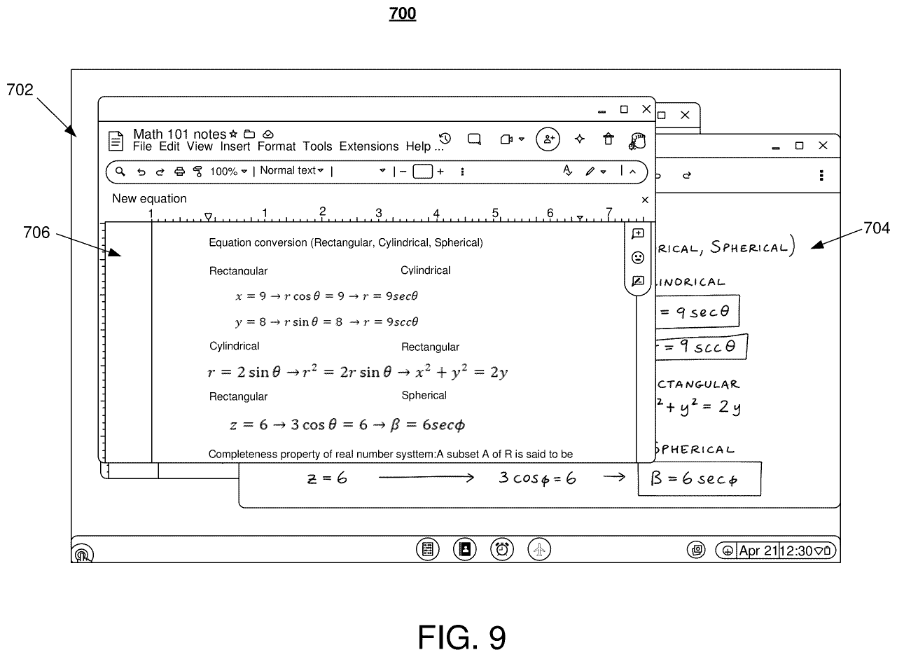

In examples, the document may be an existing document. For example, the option 718 reads, “Add to Doc - Math 101 notes.” FIG. 9 illustrates that the data and formatting types extracted from device display 702 have been inserted into the first window 704, which is titled “Math 101 notes.”

In further examples, however, the document may be a newly generated document of the document type.

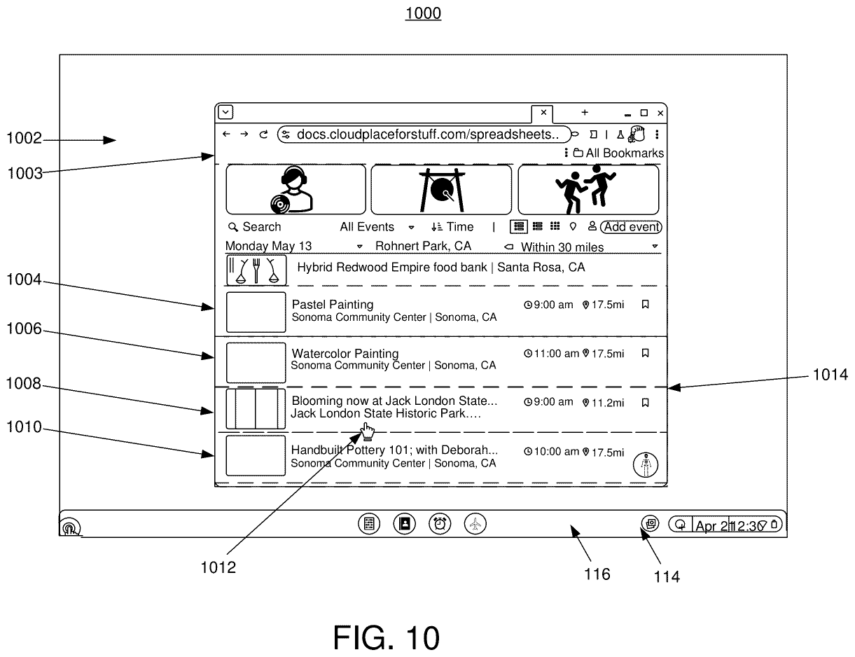

FIGS. 10-12 depict an environment 1000 for extracting content using disclosed techniques. Environment 1000 includes a device display 1002, which displays a window 1003. The environment 1000 provides an example selection of content from an image using a single selection for insertion (copy-and-pasting) into another window.

In the example of FIGS. 10-12, the window 1003 is a browser window displaying a website with a list of events. The example is not intended to be limiting, however, in further examples other applications are also possible.

In examples, the user may enter a content extraction mode where content may be selected and extracted. The content extraction may be followed by a display of an option to insert the content into another application to complete a task. The entry points for content extraction mode may include user selection of an icon 711 in the taskbar 710, selecting a menu item (not depicted), or by selecting a utility from an application launch area of an operating system (not depicted). In examples, the content extraction mode may be initiated automatically by the operating system upon selecting any location within a window, for example by clicking any location with a mouse. Other methods of launching a content extraction mode are also possible.

In the example of FIG. 10, a user visits a website with a list of events. In the example, four events are displayed in row format, each event listing an image, a title/description, a location, a time, and the distance away within an elongated rectangle. The rows with associated event information are stacked from top to bottom in four segments: a portion 1004, a portion 1006, a portion 1008, and a portion 1010.

Upon entering the content extraction mode, a user may select one event from the list of events by selecting a location 1012 with a mouse. In examples, the location 1012 comprises a single coordinate, for example an X, Y coordinate. In examples, the location 1012 may not include a range of coordinates or a region.

Upon selecting a location on device display 1002 after initiating the content extraction mode, an image 1014 and the coordinates of the location 1012 may be received at a content selection module. In examples, the image 1014 may include the entirety of the device display 1002, just the window that has focus, or a portion of the window with focus.

To determine what content from the image 1014 was selected at a single location 1012, the content selection module segments the image 1014 into portions of related content. This segmentation may be achieved by analyzing the visual and structural layout of the image. For instance, the system can use a vision-based model to detect repeating structural elements or patterns, such as the distinct rectangular containers for each event shown in FIG. 10. The model can identify visual separators like lines or whitespace that define the boundaries between these elements. Once the image 1014 is partitioned into these logical segments (e.g., portion 1008 and portion 1010), the system correlates the coordinates of the user's selection of the location 1012 with one of the identified segments. The content within the boundaries of that specific segment is then considered the user's intended selection. In the example, each segment includes data related to a specific event. For example, the image 1014 may be segmented into the portion 1008 including first related data and the portion 1010 including second related data.

A content selection module may determine that location 1012 is positioned in portion 1010. The content selection module may then extract data from the portion 1010 using any of the methods described above.

Upon extracting the data from the portion 1010, an option generation module may identify a task that may be related to the extracted data. In examples, the option generation module may display an option to execute a task based on past user behavior. For example, with user permission, the option generation module may access a browser history or a process log to determine that a calendar application is viewed multiple times a day.

In examples, the option generation module may use a language model to determine what tasks and/or applications may be associated with the extracted data. An example prompt may be, “what task is a user likely to perform with the extracted data?”

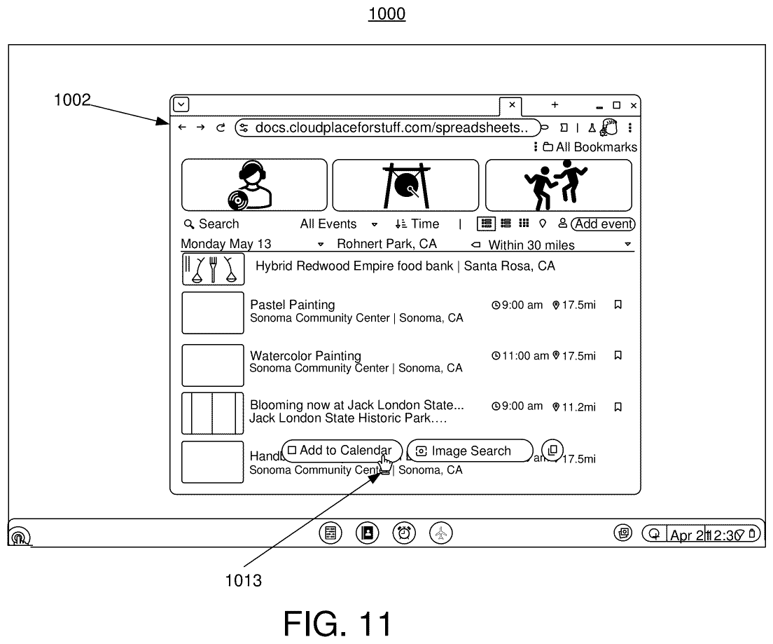

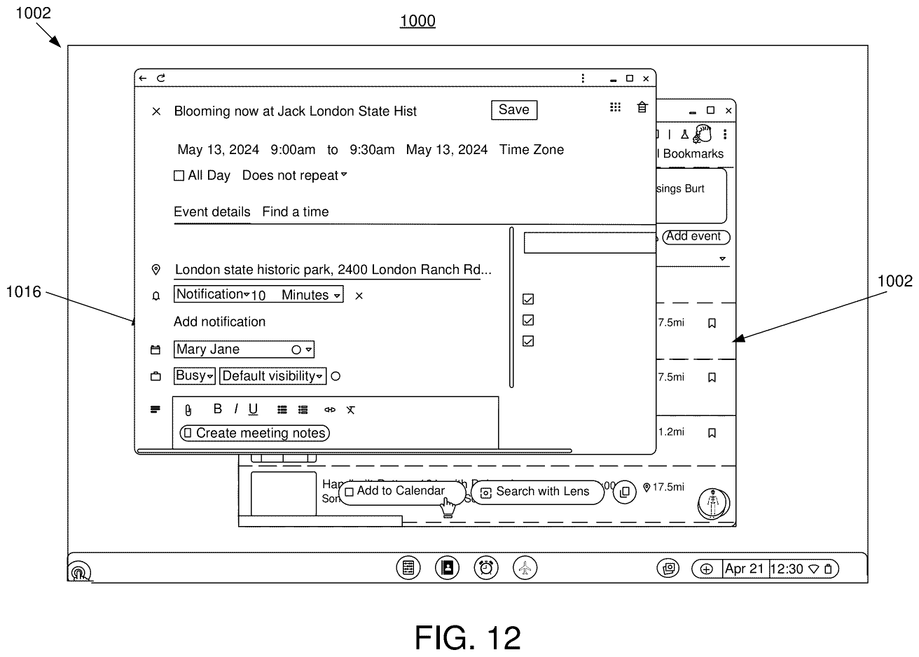

In FIG. 11, the option 1013 is displayed, which reads, “Add to Calendar”. FIG. 12 illustrates that, upon selecting the option 1013, the extracted data may be automatically added to a second window 1016 executing within a calendar application. The extracted data from the portion 1010 is populated into the fields of the image 1014 application, including the title/description of the event, the date, the time, and the location of the event. Upon selecting the save 1017 button, the event will be saved to the user's calendar.

The example of inserting events into a calendar application is not meant to be limiting. In further examples, other types of content may be selected for insertion into other types of applications.

In examples, any features described with respect to the environment 700 and the environment 1000 may be combined.

In examples, further use cases may include a user taking a screenshot of a data table from a webpage saved as an image. The system could recognize it as a table and offer to open it in a spreadsheet application with the rows and columns already formatted. A further use case may comprise a student capturing a screenshot with a slide from a lecture containing a bulleted list with bolded headings. The system could allow the user to paste the text directly into a word processing document, with the bullets and bold formatting intact, saving significant time and effort.

It should be understood that the example of inserting events into a calendar application is not meant to be limiting. In further examples, other types of content may be selected for insertion into other types of applications. For instance, a user may capture an image of a business card or an email signature. The system may identify and extract the relevant data, such as a name, job title, phone number, and email address. Upon extraction, the system may display an option to “Add to Contacts.” If the user selects this option, the system may launch a contacts application and automatically populate the corresponding fields (e.g., ‘Name,’ ‘Work Phone,’ ‘Email’) with the extracted data, streamlining the process of creating a new contact entry.

In another example, a user may take a screenshot of content that is visually formatted as a list, such as a recipe with numbered steps or a presentation slide with bullet points. The system may be configured to analyze the image to identify the list structure, including markers like numbers, bullets, or simple indentation. The system may then extract the text for each list item and offer an option such as “Create List in Document.” Upon selection, the system may generate a native list object in a destination application, such as a word processor or notes application, preserving the hierarchical and sequential structure of the original content.

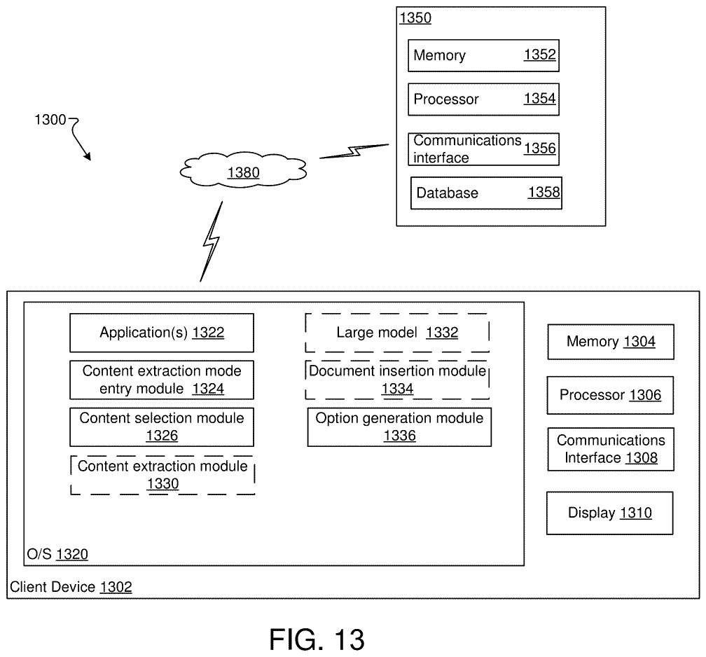

FIG. 13 depicts a block diagram of system 1300 that may execute the methods described herein, according to an example. System 1300 includes a client device 1302 and a server 1350 in communication via a network or the internet 1380.

Client device 1302 includes a non-transitory memory 1304, a processor 1306, and a communications interface 1308. Client device 1302 is in communication with a display 1310, which may be internal or external. The client device 1302 may store in the non-transitory memory 1304 instructions that, when executed by the processor 1306 cause the client device 1302 to perform operations.

The client device 1302 may include an operating system 1320 upon which application(s) 1322 may execute. Application(s) 1322 may represent specially programmed software configured to perform different functions, including creating, editing, and saving files with content.

The operating system 1320 may include instructions to execute any combination of a content extraction mode entry module 1324, a content selection module 1326, a content extraction module 1330, a language model 1332, a document insertion module 1334, and/or an option generation module 1336. The content extraction mode entry module 1324 may enable a user to select content to extract, as described above. The content selection module 1326 may determine what content from an image the user has selected, as described above. The content extraction module 1330 may extract the content into text format, possibly preserving formatting as described above. The document insertion module 1334 may generate a document to insert the extracted data into or insert the extracted data into a pre-existing document, as described above. The option generation module 1336 may generate and display options such as the options 718 and 1013 described above.

The client device 1302 may communicate with the server 1350 over a network. Server 1350 includes a non-transitory memory 1352, a processor 1354, a communications interface 1356, and a database 1358. The server 1350 may store in the non-transitory memory 1352 instructions that, when executed by the processor 1354 cause the server 1350 to perform operations.

In examples, the non-transitory memory 1352 of server 1350 may include instructions to execute any combination of content extraction module 1330, language model 1332, and/or document insertion module 1334. With user permission, the client device 1302 may send images, data, text, and formatting to non-transitory memory 1352 to execute any combination of content extraction module 1330, language model 1332, and/or document insertion module 1334.

The server 1350 may be a computing device or computing devices that take the form of a standard server, a group of such servers, or a rack server system. In some examples, the server 1350 may be a single system sharing components such as processors and memories. The network may include the Internet and/or other types of data networks, such as a local area network (LAN), a wide area network (WAN), a cellular network, satellite network, or other types of data networks.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, have many alternate forms and should not be construed as limited to only the implementations set forth herein.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

The terminology used herein is for the purpose of describing particular implementations only and is not intended to be limiting of example implementations. As used herein, the singular forms a, an, and the are intended to include the plural forms as well, unless the context clearly indicates otherwise. The terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. Terms, e.g., those defined in commonly used dictionaries, should be interpreted as having a meaning that is consistent with their meaning in the context of the relevant art and not in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), Graphics Processing Units (GPUs), digital signal processors (DSPs), application-specific-integrated-circuits, field programmable gate arrays (FPGAs) computers or the like.

All of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM) and may be read only or random access. Similarly, the transmission medium may be twisted wire pairs, coaxial cable, optical fiber, or some other suitable transmission medium known to the art. The example implementations are not limited by these aspects of any given implementation.

Lastly, whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

In some aspects, the techniques described herein relate to a method, further including: receiving a selection of the option; and in response to the selection, inserting the text into the second document and applying the formatting style to the text.

In some aspects, the techniques described herein relate to a method, wherein preserving the formatting style further includes: determining a spatial relationship between a first portion of the text and a second portion of the text; and generating formatting instructions to insert into the second document that preserve the spatial relationship between the first portion and the second portion when displayed in the second document.

In some aspects, the techniques described herein relate to a method, wherein the first document has a first document type and the second document has a second document type that is different from the first document type.

In some aspects, the techniques described herein relate to a method, wherein generating the formatting instructions includes generating a set of markup language tags that define the spatial relationship using a model with the image data as input.

In some aspects, the techniques described herein relate to a method, wherein the formatting style further includes generating the formatting style using a multi-modal language model trained to correlate visual patterns in the image data with corresponding formatting instructions.

In some aspects, the techniques described herein relate to a method, wherein the option is a first option and the method further includes: generating the second document; generating a metadata value for a metadata field for the second document based on the text; and displaying a second option that, responsive to selection, set the metadata value in the second document.

In some aspects, the techniques described herein relate to a system, wherein the memory is further configured with code operable to: receive a selection of the option; and in response to the selection, insert the text into the second document and applying the formatting style to the text.

In some aspects, the techniques described herein relate to a system, wherein preserving the formatting style further includes: determining a spatial relationship between a first portion of the text and a second portion of the text; and generating formatting instructions to insert into the second document that preserve the spatial relationship between the first portion and the second portion when displayed in the second document.

In some aspects, the techniques described herein relate to a system, wherein the first document has a first document type and the second document has a second document type that is different from the first document type.

In some aspects, the techniques described herein relate to a system, wherein generating the formatting instructions includes generating a set of markup language tags that define the spatial relationship using a model with the image data as input.

In some aspects, the techniques described herein relate to a system, wherein the formatting style further includes generating the formatting style using a multi-modal language model trained to correlate visual patterns in the image data with corresponding formatting instructions.

In some aspects, the techniques described herein relate to a system, wherein the option is a first option and the memory is further configured with code operable to: generate the second document; generate a metadata value for a metadata field for the second document based on the text; and display a second option that, responsive to selection, set the metadata value in the second document.

In some aspects, the techniques described herein relate to a non-transitory computer-readable medium, the instructions further cause the processor to: receive a selection of the option; and in response to the selection, insert the text into the second document and applying the formatting style to the text.

In some aspects, the techniques described herein relate to a non-transitory computer-readable medium, wherein preserving the formatting style further includes: determining a spatial relationship between a first portion of the text and a second portion of the text; and generating formatting instructions to insert into the second document that preserve the spatial relationship between the first portion and the second portion when displayed in the second document.

In some aspects, the techniques described herein relate to a non-transitory computer-readable medium, wherein the first document has a first document type and the second document has a second document type that is different from the first document type.

In some aspects, the techniques described herein relate to a non-transitory computer-readable medium, wherein generating the formatting instructions includes generating a set of markup language tags that define the spatial relationship using a model with the image data as input.

In some aspects, the techniques described herein relate to a non-transitory computer-readable medium, wherein the option is a first option and the instructions further cause the processor to: generate the second document; generate a metadata value for a metadata field for the second document based on the text; and display a second option that, responsive to selection, set the metadata value in the second document.

What is claimed is:

1. A method comprising:
extracting text from image data captured from a device display rendering a first document;
determining a formatting style of the text based on the image data; and
displaying an option that, responsive to selection, inserts the text into a second document and preserves the formatting style of the text.

2. The method of claim 1, further comprising:
receiving a selection of the option; and
in response to the selection, inserting the text into the second document and applying the formatting style to the text.

3. The method of claim 1, wherein preserving the formatting style further includes:
determining a spatial relationship between a first portion of the text and a second portion of the text; and
generating formatting instructions to insert into the second document that preserve the spatial relationship between the first portion and the second portion when displayed in the second document.

4. The method of claim 3, wherein the first document has a first document type and the second document has a second document type that is different from the first document type.

5. The method of claim 3, wherein generating the formatting instructions includes generating a set of markup language tags that define the spatial relationship using a model with the image data as input.

6. The method of claim 1, wherein the formatting style further includes generating the formatting style using a multi-modal language model trained to correlate visual patterns in the image data with corresponding formatting instructions.

7. The method of claim 1, wherein the option is a first option and the method further comprises:
generating the second document;
generating a metadata value for a metadata field for the second document based on the text; and
displaying a second option that, responsive to selection, set the metadata value in the second document.

8. A system comprising:
a processor; and
a memory configured with code operable to:
extract text from image data captured from a device display rendering a first document;
determine a formatting style of the text based on the image data; and
display an option that, responsive to selection, inserts the text into a second document and preserves the formatting style of the text.

9. The system of claim 8, wherein the memory is further configured with code operable to:
receive a selection of the option; and
in response to the selection, insert the text into the second document and applying the formatting style to the text.

10. The system of claim 8, wherein preserving the formatting style further includes:
determining a spatial relationship between a first portion of the text and a second portion of the text; and
generating formatting instructions to insert into the second document that preserve the spatial relationship between the first portion and the second portion when displayed in the second document.

11. The system of claim 10, wherein the first document has a first document type and the second document has a second document type that is different from the first document type.

12. The system of claim 10, wherein generating the formatting instructions includes generating a set of markup language tags that define the spatial relationship using a model with the image data as input.

13. The system of claim 8, wherein the formatting style further includes generating the formatting style using a multi-modal language model trained to correlate visual patterns in the image data with corresponding formatting instructions.

14. The system of claim 8, wherein the option is a first option and the memory is further configured with code operable to:
generate the second document;
generate a metadata value for a metadata field for the second document based on the text; and
display a second option that, responsive to selection, set the metadata value in the second document.

15. A non-transitory computer-readable medium storing instructions that, when executed by a processor, cause a processor to:
extract text from image data captured from a device display rendering a first document;
determine a formatting style of the text based on the image data; and
display an option that, responsive to selection, inserts the text into a second document and preserves the formatting style of the text.

16. The non-transitory computer-readable medium of claim 15, the instructions further cause the processor to:
receive a selection of the option; and
in response to the selection, insert the text into the second document and applying the formatting style to the text.

17. The non-transitory computer-readable medium of claim 15, wherein preserving the
formatting style further includes:
determining a spatial relationship between a first portion of the text and a second portion of the text; and
generating formatting instructions to insert into the second document that preserve the spatial relationship between the first portion and the second portion when displayed in the second document.

18. The non-transitory computer-readable medium of claim 17, wherein the first document has a first document type and the second document has a second document type that is different from the first document type.

19. The non-transitory computer-readable medium of claim 17, wherein generating the formatting instructions includes generating a set of markup language tags that define the spatial relationship using a model with the image data as input.

20. The non-transitory computer-readable medium of claim 15, wherein the option is a first option and the instructions further cause the processor to:
generate the second document;
generate a metadata value for a metadata field for the second document based on the text; and
display a second option that, responsive to selection, set the metadata value in the second document.
